(19) United States
(12) Patent Application Publication
(10) Pub. No.: US 2025/0245623 A1
(43) Pub. Date: Jul. 31, 2025

(54) MANAGEMENT DEVICE, MANAGEMENT METHOD, AND NON-TRANSITORY RECORDING MEDIUM

(71) Applicant: Rakuten Group, Inc., Tokyo (JP)

(72) Inventor: Taro ARAMAKI, Tokyo (JP)

(73) Assignee: Rakuten Group, Inc., Tokyo (JP)

(21) Appl. No.: 19/034,906

(22) Filed: Jan. 23, 2025

(30) Foreign Application Priority Data
Jan. 30, 2024 (JP) 2024-011429

(51) Int. Cl. G06Q 10/087; G06Q 30/0601

(52) U.S. Cl. CPC G06Q 10/087; G06Q 30/0625; G06Q 30/0641

(57) ABSTRACT

A management device acquires viewing history information indicating a viewing history by a user to a product sold in a store in an electronic market, calculates a number of out-of-stock views of each product, based on the viewing history included in the acquired viewing history information and determines whether or not to change a degree of replenishment that indicates a degree of priority with which a product is replenished and changes the degree of replenishment of each product, based on a determination result in the determination, the number of out-of-stock views being a number of times that a product that is out of stock is viewed, and determines whether or not the degree of replenishment is changed and to which level of a plurality of levels the degree of replenishment is changed, based on a degree-of-replenishment setting criterion set according to the number of out-of-stock views, for each product.

### CROSS-REFERENCE TO RELATED APPLICATIONS

This application claims the benefit of Japanese Patent Application No. 2024-11429, filed on Jan. 30, 2024, the entire disclosure of which is incorporated by reference herein.

### FIELD OF THE INVENTION

This application relates to a management device, a management method, and a non- transitory recording medium.

### BACKGROUND OF THE INVENTION

In recent years, various technologies for performing replenishment of products using sales data have been proposed. For example, in Japanese Patent No. 7119173, a system that acquires a sales trend with respect to a specific product and performs smooth replenishment of a product expected to be out of stock is disclosed. Various mechanisms for proposing a product optimum for a user have been proposed.

However, the above-described system has room for improvement with respect to performing inventory management matching the volume of product searches on the Internet and is not sufficient yet from a viewpoint of suitably performing inventory management.

The present disclosure has been made to solve a problem as described above, and an objective of the present disclosure is to provide a management device, a management method, and a non-transitory recording medium that, by calculating a degree of replenishment that represents a degree of priority of replenishment of inventory of a product on the Internet, enables inventory management to be suitably performed.

### SUMMARY OF THE INVENTION

A management device according to a first aspect of the present disclosure includes
one or more processors, and
the processors
acquire viewing history information indicating a viewing history by a user to a product sold in a store in an electronic market,
calculate a number of out-of-stock views of each product, based on the viewing history included in the acquired viewing history information and determine whether or not to change a degree of replenishment that indicates a degree of priority with which a product is replenished,
change the degree of replenishment of each product, based on a determination result in the determination,
the number of out-of-stock views being the number of times that a product that is out of stock is viewed, and
determine whether or not the degree of replenishment is changed and to which level of a plurality of levels the degree of replenishment is changed, based on a degree-of-replenishment setting criterion that is set according to the number of out-of-stock views, for each product.

According to the present disclosure, a management device, a management method, and a non-transitory recording medium that, by calculating a degree of replenishment that represents a degree of priority of replenishment of inventory of a product on the Internet, enables inventory management to be suitably performed can be provided.

### BRIEF DESCRIPTION OF DRAWINGS

A more complete understanding of this application can be obtained when the following detailed description is considered in conjunction with the following drawings, in which:

FIG. 1 is a diagram illustrating a relationship between a management device, information terminals, and a sales server device;

FIG. 2 is a block diagram illustrating an example of the management device;

FIG. 3 is an explanatory diagram illustrating an example of inventory information;

FIG. 4 is an explanatory diagram illustrating an example of a degree-of-replenishment setting criterion;

FIG. 5 is a block diagram illustrating an example of the sales server device;

FIG. 6 is an explanatory diagram illustrating an example of viewing history information;

FIG. 7 is an explanatory diagram illustrating a display example of an information terminal;

FIG. 8 is an explanatory diagram illustrating another display example of the information terminal;

FIG. 9 is an explanatory diagram illustrating still another display example of the information terminal;

FIG. 10 is a flowchart illustrating an example of update processing;

FIG. 11 is a flowchart illustrating an example of degree-of-replenishment change processing;

FIG. 12 is a flowchart illustrating an example of inventory information update processing;

FIG. 13 is an explanatory diagram illustrating an example of a degree-of-replenishment setting criterion in a variation;

FIG. 14 is an explanatory diagram illustrating an example of viewing history information in another variation;

FIG. 15 is an explanatory diagram illustrating an example of a degree-of-replenishment setting criterion in the another variation; and

FIG. 16 is an explanatory diagram illustrating an example of a degree-of-replenishment setting criterion in still another variation.

### DETAILED DESCRIPTION OF THE INVENTION

### Overall Configuration

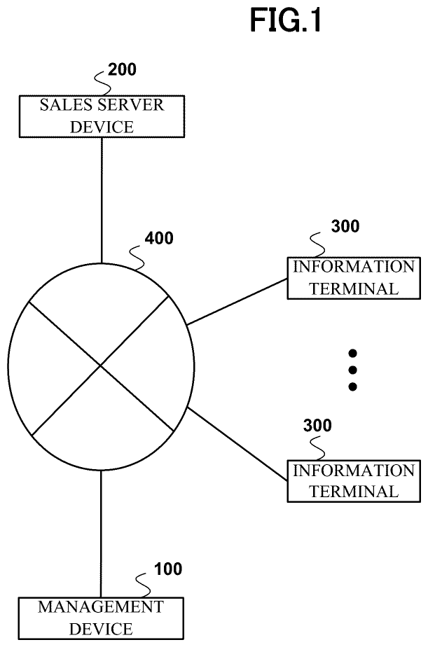

A management device, a management method, and a non-transitory recording medium according to an embodiment for embodying the present disclosure are described below in detail with reference to the drawings. Note that the same or corresponding parts in the drawings are designated by the same reference numerals. As illustrated in FIG. 1, a management device 100 according to an embodiment of the present disclosure communicably connects to a sales server device 200 via a computer communication network 400, such as the Internet. The sales server device 200 communicably connects to each information terminal 300 via the computer communication network 400.

The management device 100 is a personal computer (PC), a server, or the like (a so-called computer) that performs inventory management of products in a so-called electronic market on which a lot of virtual stores put up products for sale via the Internet, and is capable of mutually communicating with the sales server device 200 via the computer communication network 400. Specifically, the management device 100 has a function of changing a setting of a degree of replenishment that indicates a degree of priority with which products are replenished, based on a viewing history indicated by viewing history information received from the sales server device 200. As used herein, the viewing history information means history information relating to a view request for product information that an information terminal 300 made in response to a user operation. In addition, the management device 100 has a function of updating inventory information that indicates an inventory status of a product, every time the management device 100 receives purchase information from the sales server device 200. As used herein, the purchase information means history information relating to a purchase request for a product that the information terminal 300 made in response to a user operation. Note that in the embodiment, the following description is made using an electronic market of books as an example.

The sales server device 200 is a personal computer (PC), a server, or the like (a so-called computer) that manages a system of a so-called electronic market on which a lot of virtual stores put up products for sale via the Internet, and is capable of mutually communicating with each information terminal 300 via the computer communication network 400. Specifically, the sales server device 200 has a function of providing a product page corresponding to search information (search request) received from an information terminal 300. As used herein, the search information is information including information indicating a product to be searched for. In addition, the sales server device 200 has a function of updating viewing history information 212 and providing the management device 100 with the updated viewing history information 212 and a function of transmitting purchase information to the management device 100, based on purchase of a product.

Each information terminal 300 is an information terminal (a so-called computer) that a user owns, such as a smartphone, a tablet, and a personal computer (PC). The information terminal 300 performs processing of viewing and purchasing a product sold on the electronic market in response to an operation performed by the user. Specifically, the information terminal 300 performs viewing of a product by transmitting search information to the sales server device 200 and receiving a product page. In addition, the information terminal 300 performs purchase of the product in response to an operation performed by the user.

### Functional Configuration of Management Device

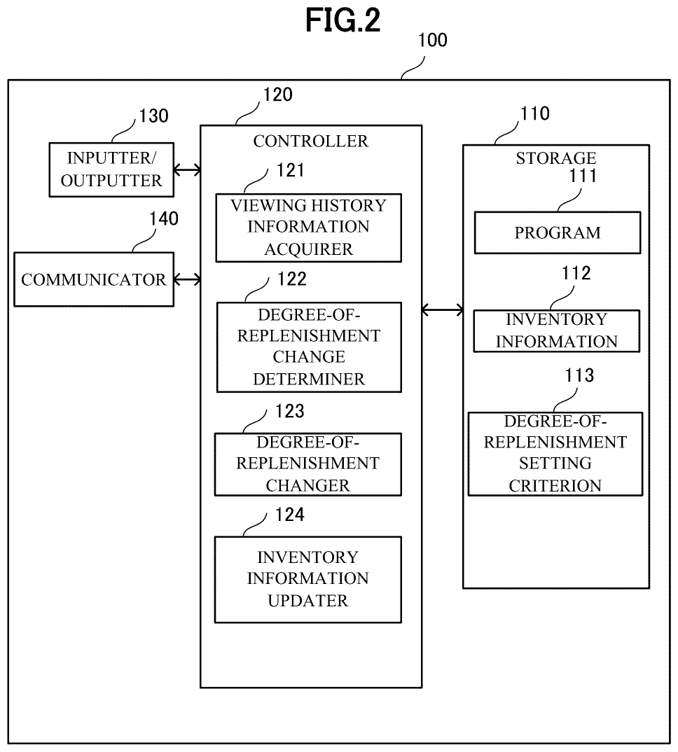

Next, with reference to FIG. 2, a configuration of the management device 100 is described.

As illustrated in FIG. 2, the management device 100 includes a storage 110, a controller 120, an inputter/outputter 130, a communicator 140, and a system bus (illustration is omitted) connecting the foregoing to one another.

The storage 110 includes a read only memory (ROM), a random access memory (RAM), and the like. The ROM stores a program 111 that the controller 120 executes, various types of data (illustration is omitted) that are required for execution of the program 111 in advance, inventory information 112, and a degree-of-replenishment setting criterion 113.

The program 111 is a program that performs degree-of-replenishment change processing and inventory information update processing, which are described later, and is stored in the storage 110 in advance.

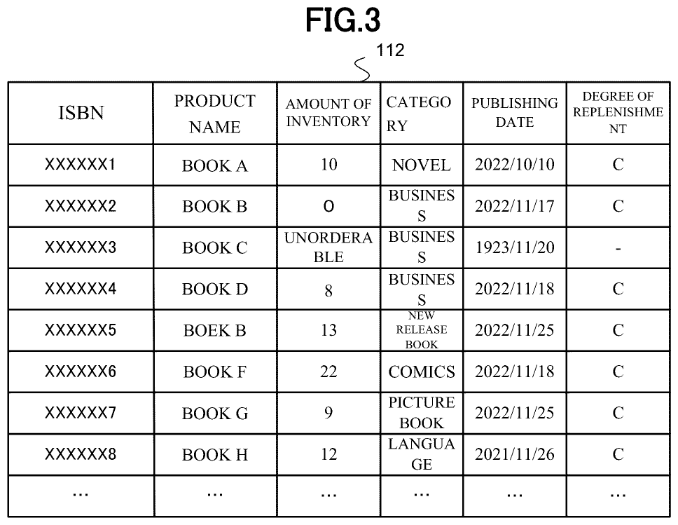

The inventory information 112 is information that indicates an inventory status of each product. Specifically, in the inventory information 112, information, such as an international standard book number (ISBN) for identifying a book, a product name indicating a book title, the amount of inventory, a category, a publishing date, and the degree of replenishment, is included, as illustrated in FIG. 3. Note that an illustrated product (book C) that has an “unorderable” status in the “the amount of inventory” column indicates a product that is out of print. In the illustrated example, an example in which the amount of inventory, the category, the publishing date, and the degree of replenishment of a “book A” having an ISBN “XXXXXX1” are currently “10”, “novel”, “2022 Oct. 10”, and “C”, respectively is illustrated. Note that in place of the ISBN in the inventory information 112, other information enabling each book to be identified may be used.

Every time a new book is published, a content of the inventory information 112 relating to the book is registered from the sales server device 200. In addition, a content of the amount of inventory included in the inventory information 112 is updated every time the management device 100 receives purchase information of the product from the sales server device 200 and the product is restocked. Further, the degree of replenishment included in the inventory information 112 is updated by the degree-of-replenishment change processing, which is described later, being performed. The degree of replenishment in the embodiment is updated in the degree-of-replenishment change processing in such a manner that the larger the number of times that a product the amount of inventory of which is “0” is viewed (the number of out-of-stock views) is, the higher the degree of replenishment becomes. The degree of replenishment being high indicates that the amount of replenishment at a time is large or that frequency of replenishment is high.

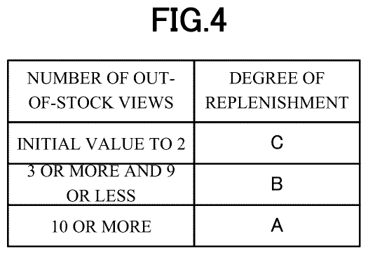

The degree-of-replenishment setting criterion 113 is information that indicates a criterion by which the degree of replenishment is changed in the degree-of-replenishment change processing, which is described later. Specifically, as the degree-of-replenishment setting criterion 113, a degree of replenishment corresponding to the number of out-of-stock views is set, as illustrated in FIG. 4. Note that settings of the number of out-of-stock views and the degree of replenishment can be arbitrarily changed, and although three levels “A” to “C” of the degree of replenishment are illustrated in the illustrated example, the degree of replenishment may be represented by a larger number of levels, such as four levels and five levels. In addition, in the present example, it is assumed that the levels “A”, “B”, and “C” of the degree of replenishment are the highest degree, the second highest degree, and the lowest degree, respectively. The number of levels of the degree of replenishment can be appropriately changed, and the degree of replenishment may be represented by a numerical value as a continuous quantity instead of being represented stepwise. Note that the degree of replenishment corresponding to the number of out-of-stock views may be calculated using, for example, artificial intelligence (AI), and in that case, a scalar quantity is to be output as the degree of replenishment. As described above, in the embodiment, the degree-of-replenishment setting criterion 113 is set in such a manner that the larger the number of out-of-stock views is, the higher the degree of replenishment becomes. The illustrated example indicates that an initial value of the degree of replenishment is set to “C” and when the number of out-of-stock views is two or less, the degree of replenishment is kept at “C”. In addition, it is indicated that when the number of out-of-stock views is three or more and nine or less, the degree of replenishment becomes “B” and when the number of out-of-stock views is greater than or equal to 10, the degree of replenishment becomes “A”. Note that although described in detail later, a daily degree-of-replenishment setting criterion 113, a weekly degree-of-replenishment setting criterion 113, and a monthly degree-of-replenishment setting criterion 113 may be individually stored in the storage 110. The illustrated example indicates the weekly degree-of-replenishment setting criterion 113.

The degree-of-replenishment setting criterion 113 is stored in the storage 110 in advance by a user of the management device 100. Note that it may be configured such that the degree-of-replenishment setting criterion 113 is set by the sales server device 200 and transmitted to the management device 100.

The controller 120 includes a central processing unit (CPU), an application specific integrated circuit (ASIC), and the like. The controller 120 operates in accordance with the program 111, which is stored in the storage 110, and performs processing in accordance with the program 111. The controller 120 includes, as major functional parts provided by the program 111 stored in the storage 110, a viewing history information acquirer 121, a degree-of-replenishment change determiner 122, a degree-of-replenishment changer 123, and an inventory information updater 124.

The viewing history information acquirer 121 is a functional part that acquires the viewing history information 212 stored in the sales server device 200. Specifically, the viewing history information acquirer 121 acquires the viewing history information 212 from the sales server device 200 every predetermined period, such as every week and every day. That is, the viewing history information acquirer 121 is a functional part that acquires a viewing history for each predetermined period, such as each week and each day. Note that the viewing history information acquirer 121 in the embodiment is assumed to acquire a weekly viewing history. In addition, the viewing history information 212 is information that indicates a viewing history of each book, and in the viewing history information 212, with respect to each ISBN and each piece of information indicating whether a corresponding book is in stock or out of stock, information indicating a user ID identifying a user who has viewed the book, a user name, and viewing date and time is included.

The degree-of-replenishment change determiner 122 is a functional part that determines whether or not a setting of the degree of replenishment, which indicates a degree of priority with which a product is replenished, is to be changed. Specifically, the degree-of-replenishment change determiner 122 determines whether or not to change the setting of the degree of replenishment, based on the number of out-of-stock views calculated based on the viewing history information 212 acquired by the function of the viewing history information acquirer 121 and a content of the degree-of-replenishment setting criterion 113 stored in the storage 110. As described above, in the embodiment, the three levels “A” to “C” of the degree of replenishment are set, and “C” is set as an initial value, as illustrated in FIG. 4. The degree-of-replenishment change determiner 122 determines not to change the setting of the degree of replenishment when the number of out-of-stock views indicated by the acquired viewing history information 212 is two or less. On the other hand, when the number of out-of-stock views is three or more and nine or less, the degree-of-replenishment change determiner 122 determines to change the degree of replenishment to “B”, and when the number of out-of-stock views is greater than or equal to 10, the degree-of-replenishment change determiner 122 determines to change the degree of replenishment to “A”. Note that the degree-of-replenishment change determiner 122 also has a function of calculating the number of out-of-stock views, based on the acquired viewing history information 212.

Returning to FIG. 2, the degree-of-replenishment changer 123 is a functional part that changes the setting of the degree of replenishment. Specifically, the degree-of-replenishment changer 123 has a function of changing the degree of replenishment to a degree of replenishment matching a determination result by the degree-of-replenishment change determiner 122.

The inventory information updater 124 is a functional part that updates the amount of inventory included in the inventory information 112. Specifically, the inventory information updater 124 has a function of decreasing the amount of inventory by a number matching the number of purchased products every time the inventory information updater 124 receives purchase information from the sales server device 200. In addition, the inventory information updater 124 has a function of adding the number of restocked products to the amount of inventory every time an out-of-stock product or an in-stock product is restocked. Note that regarding the restocking, information about the restocking may be transmitted from the sales server device 200 or may be directly input by the user of the management device 100.

The inputter/outputter 130 is a device that includes a keyboard, a mouse, a camera, a microphone, a liquid crystal display, an organic electro-luminescence (EL) display, or the like and that performs inputting and outputting of various types of data.

The communicator 140 is a device for the management device 100 to communicate with another information terminal, such as the sales server device 200, via the computer communication network 400. The foregoing is the configuration of the management device 100.

### Functional Configuration of Sales Server Device

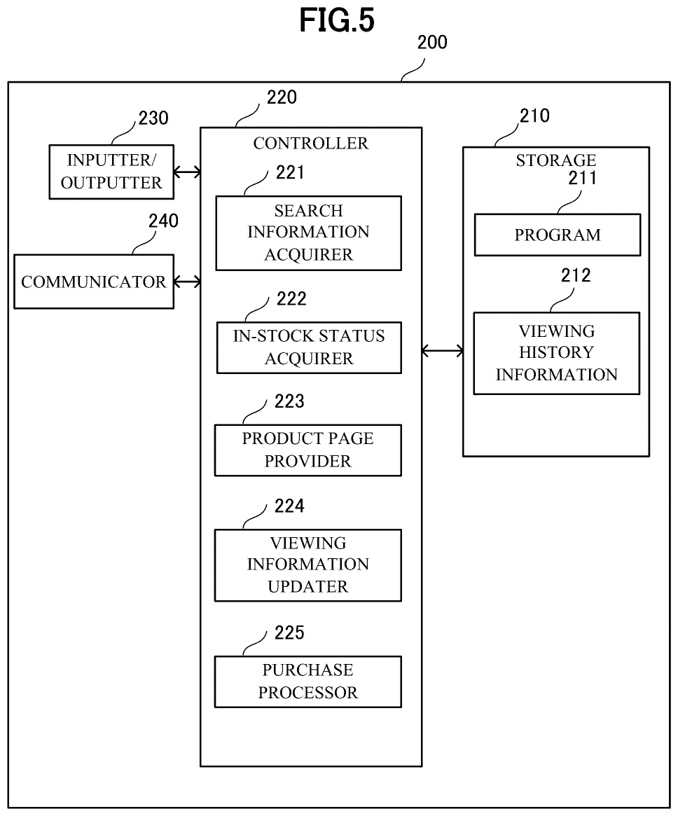

Next, with reference to FIG. 5, a configuration of the sales server device 200 is described.

As illustrated in FIG. 5, the sales server device 200 includes a storage 210, a controller 220, an inputter/outputter 230, a communicator 240, and a system bus (illustration is omitted) connecting the foregoing to one another.

The storage 210 includes a ROM, a RAM, and the like. The ROM stores a program 211 that the controller 220 executes, various types of data (illustration is omitted) that are required for execution of the program 211 in advance, and the viewing history information 212.

The program 211 is a program that performs update processing, which is described later, and is stored in the storage 210 in advance.

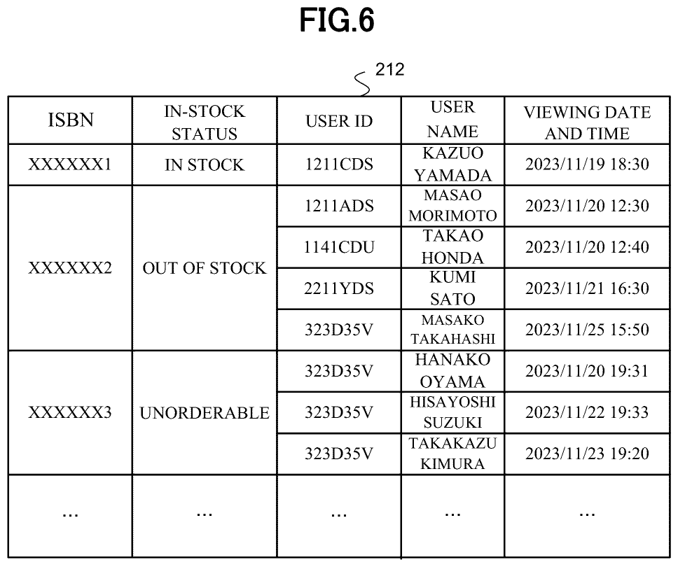

The viewing history information 212 is information that indicates a viewing history of each product. Specifically, in the viewing history information 212, at least an ISBN, information indicating whether a product indicated by the ISBN is in stock or out of stock, a user ID identifying a user who is a viewer, a user name corresponding to the user ID, and viewing date and time by the viewer are included, as illustrated in FIG. 6. As illustrated in the drawing, in the viewing history information 212 in the embodiment, a viewing history of each product (each ISBN) is indicated, and weekly information is indicated. Alternatively, daily viewing history information or monthly viewing history information may be included. That is, when weekly viewing history information is included, the viewing history information 212 is only required to be updated with new information every week and information in the past one week is only required to be saved in, for example, a database as past information.

The controller 220 includes a CPU, an ASIC, and the like. The controller 220 operates in accordance with the program 211, which is stored in the storage 210, and performs processing in accordance with the program 211. The controller 220 includes, as major functional parts provided by the program 211 stored in the storage 210, a search information acquirer 221, an in-stock status acquirer 222, a product page provider 223, a viewing information updater 224, and a purchase processor 225.

The search information acquirer 221 is a functional part that acquires search information from an information terminal 300. Specifically, the search information acquirer 221 is a functional part that acquires search information that is information transmitted by an input operation to an information terminal 300 being performed by a user and that indicates a product that the user desires, from the information terminal 300. In the search information, information about a product name, a user ID, a user name, search date and time, and the like is included. In the search information, an ISBN may be included. Note that search information being acquired by the search information acquirer 221 causes a product that the user desires to be identified. Specifically, product information is registered in the storage 210 as a database (illustration is omitted), and a product name and an ISBN corresponding to the ISBN and the product name included in the search information are to be identified from the product information. In the product information, information about an ISBN, a product name, a category, a price, a shipping charge, a publishing date, and the like is included, and such information is registered every time a new product is published.

The in-stock status acquirer 222 is a functional part that acquires an in-stock status of a product that the user desires. Specifically, the in-stock status acquirer 222 acquires an in-stock status of a product identified by the acquired search information, by confirming a content of the inventory information 112 stored in the management device 100. For example, when a case where a product identified by the acquired search information is the “book A” is described as an example, the in-stock status acquirer 222 acquires “in stock” as an in-stock status since the amount of inventory corresponding to the “book A” in the inventory information 112 illustrated in FIG. 3 is “10”. Note that the in-stock status acquirer 222 may acquire the in-stock status, based on the ISBN instead of the product name. In addition, the in-stock status acquirer 222 may acquire not only “in stock” but also the amount of inventory by including the amount of inventory in the in-stock status.

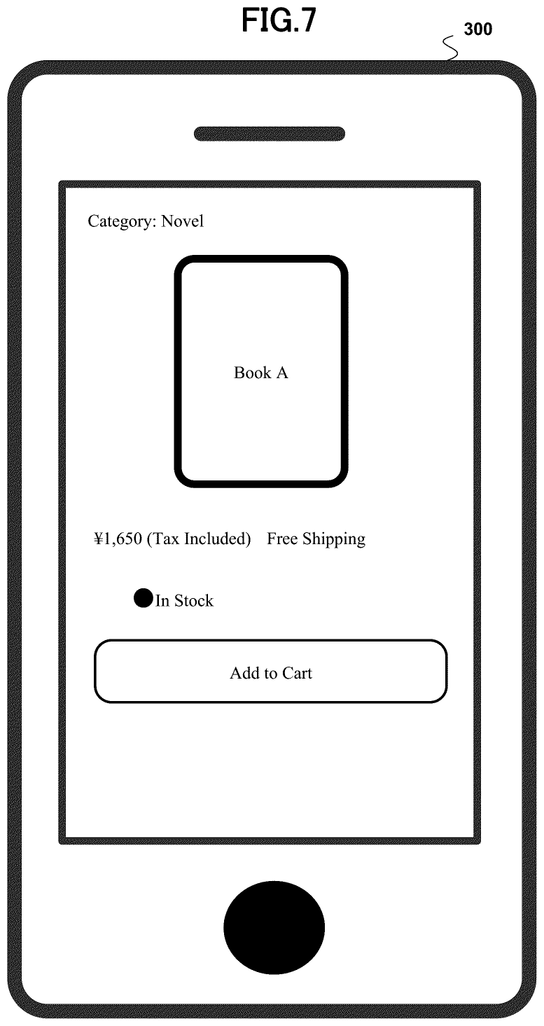

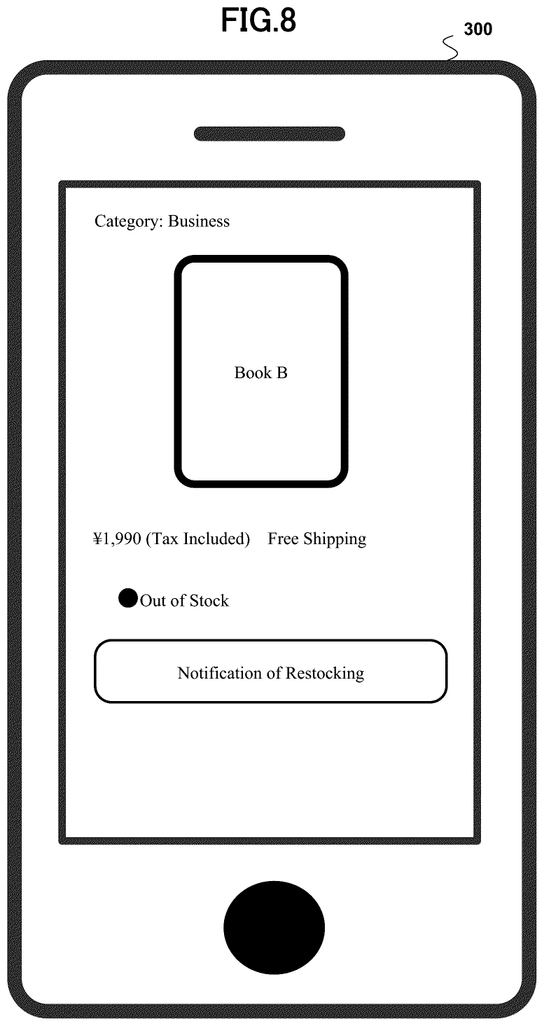

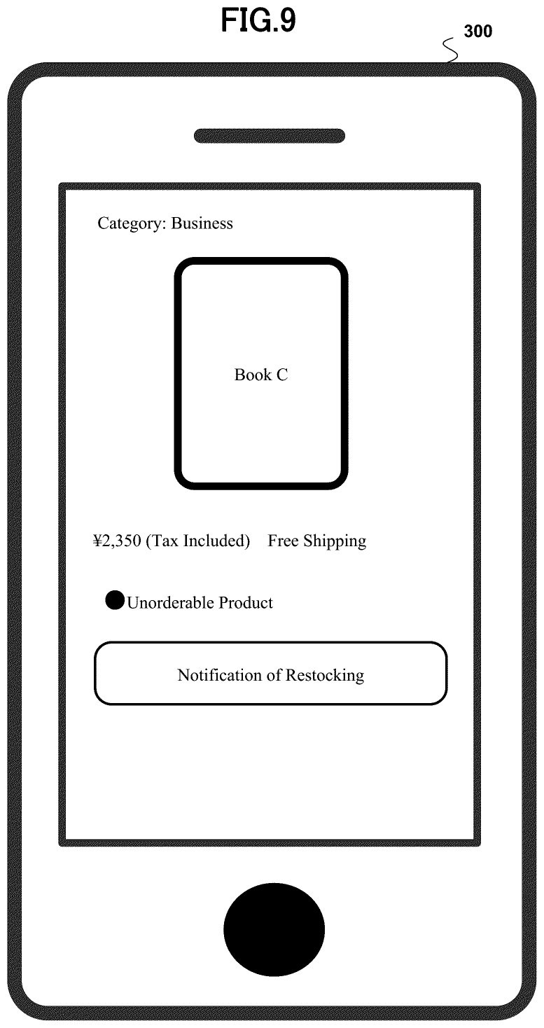

The product page provider 223 is a functional part that provides the user with a product page that is a purchase page of a product that the user desires. Specifically, the product page provider 223 has a function of generating a product page of a product identified based on search information acquired by the function of the search information acquirer 221, transmitting the generated product page to the information terminal 300, and thereby providing the user with the product page. In the product page, the in-stock status acquired by the function of the in-stock status acquirer 222 is included, and the product page provider 223 generates a product page matching the in-stock status. For example, since when the product identified by search information acquired by the function of the search information acquirer 221 is the “book A”, the in-stock status acquired by the function of the in-stock status acquirer 222 is “in stock”, the product page provider 223 generates a product page indicating that the product “book A” is in stock and can be purchased, as illustrated in FIG. 7. Note that information about a price and a category is acquired based on the product information (illustration is omitted) stored in the storage 210 in advance. In addition, when the in-stock status is “in stock”, the amount of inventory of the product may also be displayed. On the other hand, since when the product identified by search information acquired by the function of the search information acquirer 221 is the “book B”, the in-stock status acquired by the function of the in-stock status acquirer 222 is “out of stock” (see FIG. 3), the product page provider 223 generates a product page indicating that the product “book B” is out of stock and cannot be purchased, as illustrated in FIG. 8. Further, since when the product identified by search information acquired by the function of the search information acquirer 221 is the “book C”, the in-stock status acquired by the function of the in-stock status acquirer 222 is “unorderable” (see FIG. 3), the product page provider 223 generates a product page indicating that the product “book C” is an unorderable product and cannot be purchased, as illustrated in FIG. 9.

The viewing information updater 224 is a functional part that updates a content of the viewing history information 212, based on a product page being provided to the user by the function of the product page provider 223, that is, the product page being viewed by the user. Specifically, the viewing information updater 224 is a functional part that registers information about a user ID, a user name, and viewing date and time as a viewing history of a product identified by the search information acquired by the function of the search information acquirer 221. For example, since when “Masako Takahashi” having a user ID “325D35V” searched for the “book B” at “2023 Nov. 25 15:50”, a product identified by the acquired search information is the “book B”, the viewing information updater 224 identifies an ISBN to be “XXXXXX2”, based on the product information (illustration is omitted) stored in the storage 210 in advance. The viewing information updater 224 registers the above-described information as a viewing history corresponding to the ISBN “XXXXXX2”, as illustrated in FIG. 6. Note that in the illustrated example, the “book B” corresponding to the ISBN “XXXXXX2” is a product having the in-stock status “out of stock” (see FIG. 3), the number of out-of-stock views is to be updated in this case.

The purchase processor 225 is a functional part that transmits purchase information to the management device 100, based on purchase of a viewed product. Specifically, the purchase processor 225 has a function of causing the content of the inventory information 112 stored in the management device 100 to be updated by transmitting purchase information to the management device 100, based on purchase of a product by an input operation performed by a user of an information terminal 300 (reception of purchase information). In the purchase information, an ISBN, a product name, the number of purchased products, purchaser information identifying a purchaser, and the like are included. Note that the purchase processor 225 also has a function of performing payment processing of the purchased product in addition to the above-described function.

The inputter/outputter 230 is a device that includes a keyboard, a mouse, a camera, a microphone, a liquid crystal display, an organic EL display, or the like and that performs inputting and outputting of various types of data.

The communicator 240 is a device for the sales server device 200 to communicate with another information terminal, such as the management device 100 and the information terminals 300, via the computer communication network 400. The foregoing is the configuration of the sales server device 200.

### Operation

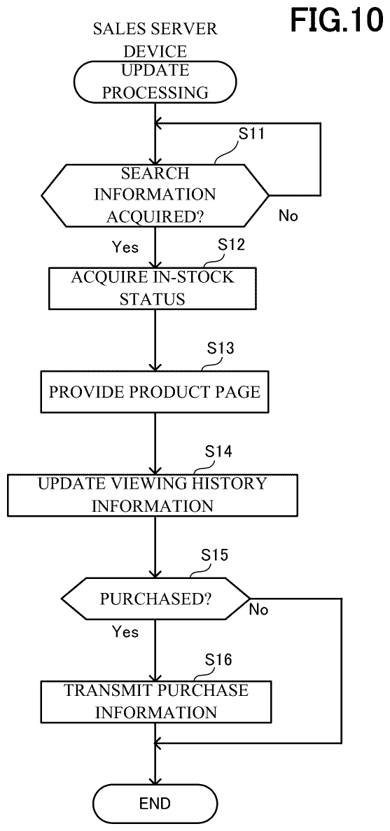

Next, operation of the management device 100 and the sales server device 200 is described with reference to FIGS. 10 to 12. FIG. 10 is a flowchart illustrating an example of the update processing in the sales server device 200. The update processing illustrated in FIG. 10 is processing in which the sales server device 200 updates the content of the viewing history information 212. The update processing in the embodiment is performed every week, and information during the past one week is saved in the database as past information at the time of performing new update processing.

In the update processing, the sales server device 200 first determines whether or not the sales server device 200 has acquired (received) search information from an information terminal 300 by the function of the search information acquirer 221 (step S11). When the sales server device 200 has not received search information (step S11; No), the sales server device 200 waits without performing anything until receiving search information.

In contrast, when the sales server device 200 has received search information (step S11; Yes), the sales server device 200 acquires an in-stock status from the management device 100 by the function of the in-stock status acquirer 222 (step S12). Specifically, in the processing in step S12, first, the search information acquirer 221 identifies a product that the user desires, based on the acquired search information. The in-stock status acquirer 222 acquires an in-stock status corresponding to the identified product, based on the content of the inventory information 112 stored in the management device 100. For example, when in a case where the product identified by the search information acquired in the processing in step S11 is the “book A”, the in-stock status acquirer 222 acquires “in stock” as the in-stock status in the processing in step S12 since the amount of inventory corresponding to the “book A” in the inventory information 112 is “10” in the example illustrated in FIG. 3.

After performing the processing in step S12, the sales server device 200 generates a product page and provides the user with the generated product page by the function of the product page provider 223 (step S13). Specifically, in the processing in step S13, the product page provider 223 generates a product page that is a purchase page of the product identified in the processing in step S12, based on the acquired in-stock status and provides the user of the information terminal 300 that is a transmission source of the search information acquired in step S11 with the generated product page. For example, since when the product identified by the acquired search information is the “book A”, the in-stock status acquired in step S12 is “in stock”, the product page provider 223 generates a product page indicating that the product “book A” is in stock and can be purchased in the processing in step S13, as illustrated in FIG. 7. Note that as described above, information about a price and a category is acquired based on the product information (illustration is omitted) stored in the storage 210 in advance. In addition, when the in-stock status is “in stock”, the amount of inventory of the product may also be displayed. On the other hand, since when the product identified by the acquired search information is the “book B”, the in-stock status acquired in step S12 is “out of stock” (see FIG. 3), the product page provider 223 generates a product page indicating that the product “book B” is out of stock and cannot be purchased in the processing in step S13, as illustrated in FIG. 8.

Further, since when the product identified by the acquired search information is the “book C”, the in-stock status acquired in step S12 is “unorderable” (see FIG. 3), the product page provider 223 generates a product page indicating that the product “book C” is an unorderable product and cannot be purchased in the processing in step $13, as illustrated in FIG. 9.

After performing the processing in step S13, the sales server device 200 updates the content of the viewing history information 212 by the function of the viewing information updater 224 (step S14). Specifically, in the processing in step S14, the viewing information updater 224 adds information about the user ID, the user name, and the viewing date and time included in the search information to the viewing history information 212 as a viewing history of the product identified by the acquired search information. For example, when the information included in the acquired search information is the product name “book B”, the user ID “325D35V”, the user name “Masako Takahashi”, and the search date and time “2023 Nov. 25 15:50”, the viewing information updater 224 identifies the ISBN to be “XXXXXX2”, based on the product information (illustration is omitted) stored in the storage 210 in advance, in the processing in step S14. In the processing in step S14, the viewing information updater 224 registers information, such as the user ID “325D35V”, the user name “Masako Takahashi”, and the search date and time “2023 Nov. 25 15:50”, as a viewing history corresponding to the ISBN “XXXXXX2”, as illustrated in FIG. 6. Note that in the illustrated example, the “book B” corresponding to the ISBN “XXXXXX2” is a product having the in-stock status “out of stock” (see FIG. 3), the number of out-of-stock views is to be updated in this case.

After performing the processing in step S14, the sales server device 200 determines whether or not the product has been purchased by the user who is provided with the product page in the processing in step S13 (step S15). Specifically, in the processing in step S15, the sales server device 200 determines whether or not the product has been purchased by determining whether or not the sales server device 200 has received purchase information indicating purchase of the product from the information terminal 300. When the product has not been purchased (step S15; No), that is, when the sales server device 200 has not received purchase information, the sales server device 200 directly terminates the update processing.

In contrast, when the product has been purchased (step S15; Yes), that is, when the sales server device 200 has received purchase information, the sales server device 200 performs payment processing of the purchased product by the function of the purchase processor 225 and also sends an instruction for the management device 100 to update the content of the inventory information 112 stored in the management device 100 by transmitting the purchase information to the management device 100 (step S16), and terminates the update processing.

The foregoing is the operation of the update processing in the sales server device 200. The update processing being performed causes a weekly viewing history by the user for each product to be stored in the storage 210 as the viewing history information 212. That is, the number of weekly out-of-stock views is to be counted. In addition, the update processing being performed causes the inventory information 112 to be updated in the management device 100 when a product is purchased.

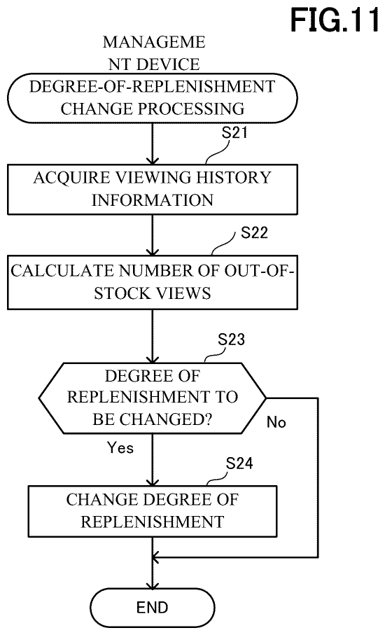

Next, operation in the management device 100 is described. FIG. 11 is a flowchart illustrating an example of the degree-of-replenishment change processing in the management device 100. The degree-of-replenishment change processing illustrated in FIG. 11 is performed at a predetermined timing. Specifically, the degree-of-replenishment change processing in the embodiment is performed every week and is, for example, performed at 23:59 every Saturday (immediately before Sunday). Note that without being limited to every week, the degree-of-replenishment change processing may be performed every month or every day. In this case, the degree-of-replenishment change processing is only required to be performed at a timing immediately before the next month or the next day, such as 23:59 on the last day of a month and 23:59 on the day. In addition, the execution timing of the degree-of-replenishment change processing can be changed to an arbitrary timing corresponding to one of daily, weekly, and monthly frequencies, and the degree-of-replenishment change processing may also be performed at a plurality of timings. In this case, the daily degree-of-replenishment setting criterion 113, the weekly degree-of-replenishment setting criterion 113, and the monthly degree-of-replenishment setting criterion 113 are only required to be individually stored in the storage 110, and determination of the execution timing of the degree-of-replenishment change processing is only required to be performed in the processing in step S23, based on a degree-of-replenishment setting criterion 113 corresponding to each execution timing.

When starting the degree-of-replenishment change processing, the management device 100 first acquires the viewing history information 212 from the sales server device 200 by the function of the viewing history information acquirer 121 (step S21). Specifically, in the processing in step S21, the viewing history information acquirer 121 acquires the viewing history information 212 (see FIG. 6) that is stored in the sales server device 200 and that indicates a viewing history in a current week (step S21). Note that when, for example, the degree-of-replenishment change processing is performed every month, monthly viewing history information 212 is only required to be acquired based on the past information saved in the database, in addition to weekly viewing history information 212, in the processing in step S21. When the degree-of-replenishment change processing is performed every day, the viewing history information 212 to be stored in the sales server device 200 is only required to be updated with new information every day and information in the past is only required to be saved in, for example, a database as past information.

After performing the processing in step S21 illustrated in FIG. 11, the management device 100 calculates the number of out-of-stock views, based on the viewing history information 212 acquired in the processing in step S21 by the function of the degree-of-replenishment change determiner 122 (step S22). Specifically, in the processing in step S22, the degree-of-replenishment change determiner 122 calculates the number of out-of-stock views by counting the number of views corresponding to records the item “in-stock status” of which is “out of stock” in the acquired viewing history information 212. For example, when a case where the viewing history information 212 illustrated in FIG. 6 is acquired in the processing in step S21 is described as an example, the degree-of-replenishment change determiner 122 calculates “4” that is the number of views corresponding to records the ISBN of which is “XXXXXX2” and the item “in-stock status” of which is “out of stock”, as the number of out-of-stock views, in the processing in step S22. Note that although in the example, an example in which only the number of views corresponding to records the ISBN of which is “XXXXXX2” is calculated is described, in the processing in step S22, the degree-of-replenishment change determiner 122 calculates the number of views corresponding to records of all products the item “in-stock status” of which is “out of stock”, that is, the number of out-of-stock views corresponding to all products (the number of out-of-stock views for each product).

Returning to FIG. 11, after performing the processing in step S22, the management device 100 determines whether or not to change the degree of replenishment by the function of the degree-of-replenishment change determiner 122 (step S23). Specifically, in the processing in step S23, the degree-of-replenishment change determiner 122 determines whether or not to change the setting of the degree of replenishment, based on the number of out-of-stock views calculated in the processing in step S22 and the content of the degree-of-replenishment setting criterion 113 stored in the storage 110. For example, when a case where the number of out-of-stock views calculated in the processing in step S22 is “4” (the number of views corresponding to records the ISBN of which is “XXXXXX2”) and the degree-of-replenishment setting criterion 113 stored in the storage 110 has a content illustrated in FIG. 4 is described as an example, in the processing in step S23, the degree-of-replenishment change determiner 122 determines to change the degree of replenishment of the product corresponding to the ISBN “XXXXXX2” to “B”. Note that in the case where the daily degree-of-replenishment setting criterion 113, the weekly degree-of-replenishment setting criterion 113, and the monthly degree-of-replenishment setting criterion 113 are individually stored in the storage 110, even when the degree-of-replenishment change determiner 122, for example, determines to change the degree of replenishment in such a manner as to upgrade the degree of replenishment from “C” to “B”, based on the weekly degree-of-replenishment setting criterion 113 in the processing in step S23, the degree-of-replenishment change determiner 122 may determine to change the degree of replenishment in such a manner as to degrade the degree of replenishment from “B” to “C”, based on the monthly degree-of-replenishment setting criterion 113 in the processing in step S23 performed at a timing in accordance with monthly execution. On the contrary, the degree-of-replenishment change determiner 122 may determine to change the degree of replenishment in such a manner as to further upgrade the degree of replenishment from “B” to “A”, based on the monthly degree-of-replenishment setting criterion 113.

Returning to FIG. 11, when the management device 100 determines to change the degree of replenishment in the processing in step S23 (step S23; Yes), the management device 100 changes the degree of replenishment to a degree of replenishment corresponding to a determination result to which the management device 100 determines to change the degree of replenishment in the processing in step S23, by the function of the degree-of-replenishment changer 123 (step S24) and terminates the degree-of-replenishment change processing. For example, when the degree of replenishment of the product corresponding to the ISBN “XXXXXX2” is determined to be changed to “B” in the processing in step S23, the degree-of-replenishment changer 123 changes the degree of replenishment of the product corresponding to the ISBN “XXXXXX2” in the inventory information 112 illustrated in FIG. 3 from “C” to “B”, in the processing in step S24.

Returning to FIG. 11, when the management device 100 determines not to change the degree of replenishment in the processing in step S23 (step S23; No), the management device 100 directly terminates the degree-of-replenishment change processing.

The foregoing is the operation of the degree-of-replenishment change processing in the management device 100. By the degree-of-replenishment change processing being performed, the degree of replenishment can be changed according to the number of out-of-stock views, and the inventory management can be suitably performed. In addition, even when the management device 100 changes the degree of replenishment in such a manner as to upgrade the degree of replenishment from “C” to “B”, based on the weekly degree-of-replenishment setting criterion 113, the management device 100 may change the degree of replenishment in such a manner as to degrade the degree of replenishment from “B” to “C”, based on the number of out-of-stock views in the month and the monthly degree-of-replenishment setting criterion 113 in the processing in step S23 performed at a timing in accordance with monthly execution. On the other hand, the management device 100 may change the degree of replenishment in such a manner as to further upgrade the degree of replenishment from “B” to “A”. Because of this configuration, since the degree of replenishment can be changed according to the number of weekly out-of-stock views and the number of monthly out-of-stock views, the inventory management can be more suitably performed.

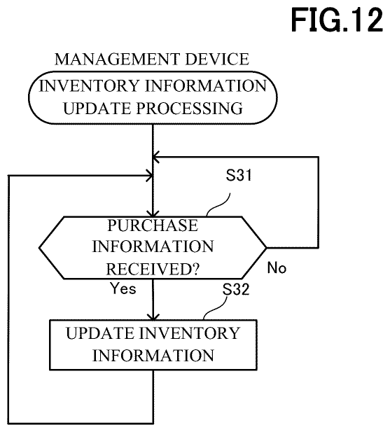

Next, the inventory information update processing in the management device 100 is described with reference to FIG. 12. FIG. 12 is a flowchart illustrating an example of the inventory information update processing in the management device 100. Performance of the inventory information update processing in the embodiment is started based on an operation by the user. Although in the illustrated example, an example in which the inventory information update processing is constantly performed is described, the inventory information update processing may be performed every time purchase information is received from the sales server device 200. In addition, although illustration is omitted, not only when a product is purchased and the amount of inventory decreases, that is, when purchase information is received, but also when the amount of inventory newly increases, the inventory information update processing is performed based on an operation by the user or an instruction from the sales server device 200. In this case, among the inventory information 112 stored in the storage 110, the amount of inventory of a product indicated in a content of an operation by the user or a content of an instruction from the sales server device 200 is only required to increase.

When starting the inventory information update processing, the management device 100 first determines whether or not the management device 100 has received purchase information from the sales server device 200 (step S31). Purchase information is transmitted from the sales server device 200 to the management device 100 by the processing in step S16 illustrated in FIG. 10 being performed. The purchase information is information to be transmitted when a product is purchased, and in the purchase information, an ISBN, a product name, the number of purchased products, purchaser information identifying a purchaser, and the like are included.

When in the processing in step S31 illustrated in FIG. 12, the management device 100 determines that the management device 100 has not received purchase information (step S31; No), the management device 100 waits without performing anything until receiving search information. In contrast, when the management device 100 determines that the management device 100 has received purchase information (step S31; Yes), the management device 100 updates the content of the inventory information 112 stored in the storage 110, by the function of the inventory information updater 124 (step S32) and terminates the inventory information update processing. Specifically, in the processing in step S32, the inventory information updater 124 updates the content of the inventory information 112 by decreasing the amount of inventory of a product corresponding to an ISBN identified by the received purchase information among the inventory information 112 by the number of purchased products identified by the purchase information.

The foregoing is the operation of the inventory information update processing in the management device 100. The inventory information update processing being performed causes the inventory information 112 to be updated.

### Variations

Note that the present disclosure is not limited to the above-described embodiment and various modifications and applications are possible. For example, the management device 100 according to the above-described embodiment does not have to include all the technical features described above and may be a management device including a portion of the configuration described in the above-described embodiment to solve at least one problem in conventional technology. In addition, at least some of variations described below may be combined.

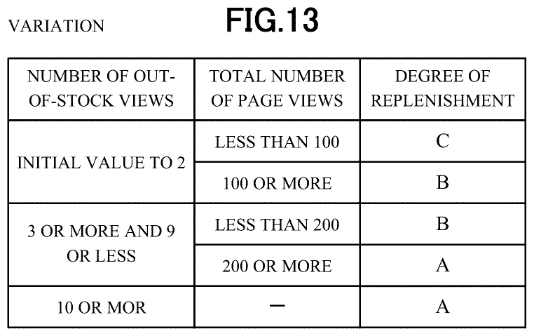

Although in the above-described embodiment, an example in which a degree of replenishment corresponding to the number of out-of-stock views is set as the degree-of-replenishment setting criterion 113, as illustrated in FIG. 4 and necessity of change in the degree of replenishment is determined according to the number of out-of-stock views by the processing in step S23 in FIG. 11 is described, the configuration is only an example. For example, as illustrated in FIG. 13, the necessity of change in the degree of replenishment may be determined based on the number of weekly out-of-stock views and the total number of page views. The example illustrated in FIG. 13 indicates that an initial value of the degree of replenishment is set to “C” and when the total number of page views is greater than or equal to “100”, the degree of replenishment is set to “B” even when the number of out-of-stock views is two or less. In addition, it is indicated that when the total number of page views is greater than or equal to “200”, the degree of replenishment is set to “A” even when the number of out-of-stock views is three or more and nine or less.

That is, the necessity of change in the degree of replenishment may be determined in such a manner that the larger, in addition to the number of out-of-stock views, the number of times that the product is viewed by the user regardless of the in-stock status of the product, the higher the degree of replenishment becomes. The total number of page views may be, for example, the number of all page views in the past or the total number of yearly, monthly, or weekly page views. When the total number of yearly, monthly, or weekly page views is used, the total number of page views is only required to be reset to “0” every corresponding period. In the total number of page views, the number of views in the case where the in-stock status is “in stock” is included. Note that regarding the total number of page views, when the viewing history information 212 is updated in the processing in step S14 in FIG. 10, the number of all page views in the past (or the total number of yearly, monthly, or weekly page views) is only required to be counted. Because of this configuration, the degree of replenishment can be changed according to the number of all page views in addition to the number of out-of-stock views, and the inventory management can be more suitably performed.

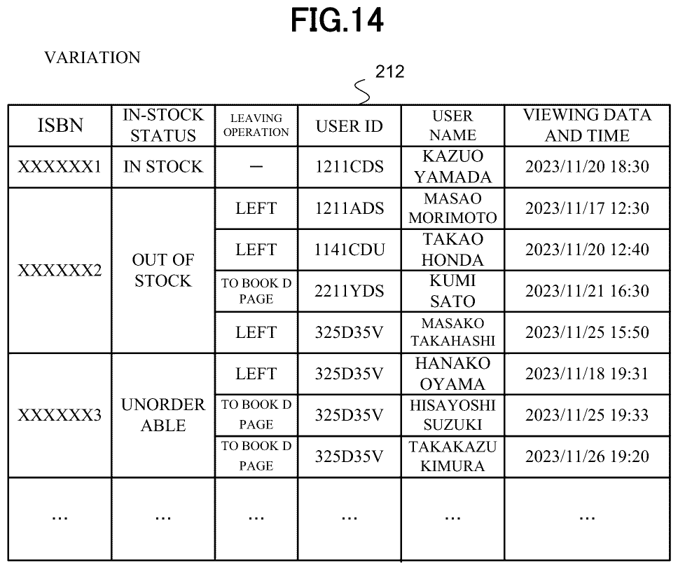

In addition, although in the above-described embodiment, an example in which in the viewing history information 212, at least an ISBN, information indicating whether a product indicated by the ISBN is in stock or out of stock, a user ID identifying a user who is a viewer, a user name corresponding to the user ID, and viewing date and time by the viewer are included, as illustrated in FIG. 6 is described, the configuration is only an example. In the viewing history information 212, for example, information indicating whether or not the user performed page transition from the product page to another product page or leaving operation information indicating that the user has left the store in the electronic market when an inventory status of a product indicated by the product page is “out of stock” or “unorderable” may be included, as illustrated in FIG. 14.

Specifically, when after a product page is provided by the processing in step S13 illustrated in FIG. 10, the inventory status of a product indicated by the product page is “out of stock” or “unorderable” and the user requests provision of another product page, the requested product page is only required to be registered as a transition destination in the viewing history information 212, in the processing in step S14. When description is made using the example illustrated in FIG. 14, the example indicates that a user with a user name “Kumi Sato”, after viewing a product page of the “book B” with the ISBN “XXXXXX2”, viewed a product page of a “book D”. In addition, when after a product page is provided by the processing in step S13 illustrated in FIG. 10, the inventory status of a product indicated by the product page is “out of stock” or “unorderable” and the user leaves the store in the electronic market, information indicating the leaving operation is only required to be registered in the viewing history information 212. When description is made using the example illustrated in FIG. 14, the example indicates that a user with a user name “Masao Morimoto”, after viewing the product page of the “book B” with the ISBN “XXXXXX2”, left the store in the electronic market. Note that regarding the leaving operation, it is only required to determine that the user has left the store when, for example, the user terminates the application or performs transition to a background state.

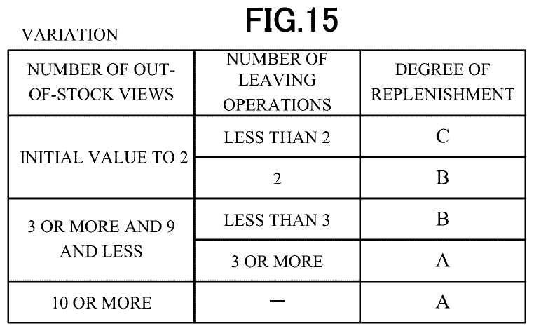

After the determination, for example, the necessity of change in the degree of replenishment may be determined based on the number of weekly out-of-stock views and the number of leaving operations, as illustrated in FIG. 15. The example illustrated in FIG. 15 indicates that an initial value of the degree of replenishment is set to “C” and when the number of leaving operations is equal to “2”, the degree of replenishment is set to “B” even when the number of out-of-stock views is two or less. In addition, it is indicated that even when the number of out-of-stock views is three or more and nine or less, the degree of replenishment is set to “A” when the number of leaving operations is greater than or equal to “3”. That is, the degree-of-replenishment setting criterion 113 is set in such a manner that the larger the number of leaving operations is, the higher the degree of replenishment becomes. Note that the number of leaving operations is only required to be calculated at the same time as when the number of out-of-stock views is calculated in the processing in step S22 in FIG. 11. Because of this configuration, the degree of replenishment can be set to a degree of replenishment based on the number of leaving operations in addition to the number of out-of-stock views, and the inventory management can be more suitably performed.

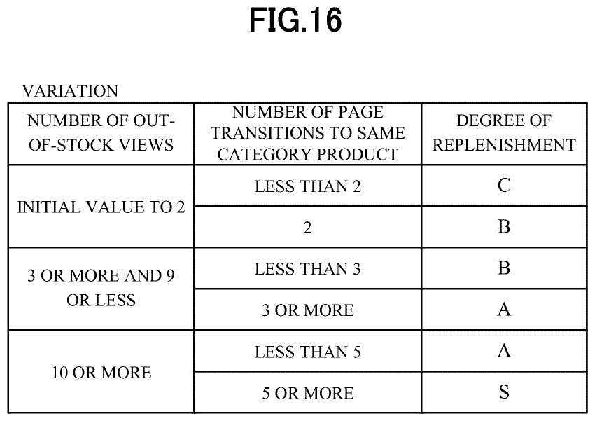

In addition, for example, the necessity of change in the degree of replenishment may be determined based on the number of weekly out-of-stock views and the number of page transitions to a product of the same category, as illustrated in FIG. 16. The example illustrated in FIG. 16 indicates that an initial value of the degree of replenishment is set to “C” and when the number of page transitions to a product of the same category is equal to “2”, the degree of replenishment is set to “B” even when the number of out-of-stock views is two or less. In addition, it is indicated that even when the number of out-of-stock views is three or more and nine or less, the degree of replenishment is set to “A” when the number of page transitions to a product of the same category is greater than or equal to “3”. In addition, it is indicated that even when the number of out-of-stock views is greater than or equal to 10, the degree of replenishment is set to “S” that is a special degree of replenishment when the number of page transitions to a product of the same category is greater than or equal to “5”. That is, the degree-of-replenishment setting criterion 113 is set in such a manner that the larger the number of page transitions to a product of the same category is, the higher the degree of replenishment becomes. Note that the number of page transitions to a product of the same category is only required to be calculated at the same time as when the number of out-of-stock views is calculated in the processing in step S22 in FIG. 11. Whether or not a product is a product of the same category is only required to be determined with reference to, for example, the inventory information 112, and when the product belongs to the same category as a transition source product, the number of views of the product is only required to be counted. Because of this configuration, the degree of replenishment can be changed according to the number of page transitions to a product of the same category in addition to the number of out-of-stock views, and the inventory management can be more suitably performed. Further, the degree of replenishment can be set to a special degree of replenishment, and the inventory management can be more suitably performed. Note that the special degree of replenishment is applicable to not only change in the degree of replenishment according to the number of weekly out-of-stock views and the number of page transitions to a product of the same category but also other cases. In addition, the page transition to a product of the same category is a page transition to a product of the same category in the same electronic market.

Note that although in the example illustrated in FIG. 14, only one page transition, such as a user with a user name “Kumi Sato” having viewed the product page of the “book B” with the ISBN “XXXXXX2” and subsequently having viewed the product page of the “book D”, is illustrated, even when the user “Kumi Sato” views products belonging to the same category (in the example, a category “business” (see FIG. 3)) in such a manner as to travel around the products, such as “Kumi Sato” further viewing, after the product page of the “book D”, the product page of the “book C”, that is, even when “Kumi Sato” successively views products belonging to the same category, such viewing history information is only required to be stored as the viewing history information 212. The degree-of-replenishment setting criterion 113 may be set in such a manner that the longer the traveling around the products belonging to the same category is, that is, the larger the number of successive page views of the products belonging to the same category in the same user is, the higher the degree of replenishment becomes.

In addition, although in the above-described embodiment, the description is made using an electronic market of books as an example, application target of the above-described embodiment is not limited to the electronic market of books. In addition to the example, an application target may be an electronic market in which various types of products, such as household appliances, are sold.

Note that the management device 100, the sales server device 200, and the information terminals 300 according to the above-described embodiment can be achieved using a general computer without depending on a dedicated device. For example, the management device 100 that performs the above-described processing may be configured by installing a program for causing the computer to perform one of the above-described types of processing in the computer from a non-transitory recording medium storing the program. In addition, the management device 100, the sales server device 200, and the information terminal 300 may be configured by a plurality of computers operating in collaboration with one another.

In addition, when the above-described functions are achieved by sharing of operation between an operating system (OS) and an application or collaboration between the OS and the application, only programs other than the OS may be stored in the medium.

In addition, it is possible to superimpose programs on a carrier wave and distribute the programs via a communication network. For example, the programs may be posted on a bulletin board system (BBS) on the communication network and distributed via the network. It may be configured such that the above-described processing can be performed by starting the distributed programs and executing the programs in a similar manner to other application programs under the control of the operating system.

Hereinafter, various modes of embodiment of the present disclosure are collectively described as Appendices.

(Appendix 1) A management device, comprising one or more processors,
wherein the processors
acquire viewing history information indicating a viewing history by a user to a product sold in a store in an electronic market,
calculate a number of out-of-stock views of each product, based on the viewing history included in the acquired viewing history information and determine whether or not to change a degree of replenishment that indicates a degree of priority with which a product is replenished,
change the degree of replenishment of each product, based on a determination result in the determination,
the number of out-of-stock views being a number of times that a product that is out of stock is viewed, and
determine whether or not the degree of replenishment is changed and to which level of a plurality of levels the degree of replenishment is changed, based on a degree-of-replenishment setting criterion that is set according to the number of out-of-stock views, for each product.

(Appendix 2) The management device according to appendix 1, wherein
in the viewing history information, a total number of views of each product that includes a view of the product when the product is out of stock and a view of the product when the product is in stock is included, and
the processors determines whether or not the degree of replenishment is changed and to which level of a plurality of levels the degree of replenishment is changed, based on a degree-of-replenishment setting criterion that is set according to the number of out-of-stock views and the total number of views, for each product.

(Appendix 3) The management device according to appendix 1 or 2, wherein
in the viewing history information, leaving operation information indicating that after a product that is out of stock is viewed, the user left the electronic market is included, and
the processors
   further calculate a number of leaving operations for each product, based on the leaving operation information, and
   determines whether or not the degree of replenishment is changed and to which level of a plurality of levels the degree of replenishment is changed, based on a degree-of-replenishment setting criterion that is set according to the number of out-of-stock views and the number of leaving operations, for each product.

(Appendix 4) The management device according to any one of appendices 1 to 3, wherein
in the viewing history information, different product viewing information indicating that after a product that is out of stock is viewed, the user in the electronic market viewed a product different from the product is included, and
the processors
   further calculate a number of same category product views that is a number of views of a product belonging to a same category as the product that the user viewed and that is out of stock, based on the different product viewing information, and
   determines whether or not the degree of replenishment is changed and to which level of a plurality of levels the degree of replenishment is changed, based on a degree-of-replenishment setting criterion that is set according to the number of out-of-stock views and the number of same category product views, for each product.

(Appendix 5) The management device according to any one of appendices 1 to 4, wherein
in the viewing history information, different product successive viewing information indicating that after the product that is out of stock is viewed, the user in the electronic market successively views products different from the product is included, and
the processors
   further calculate a number of same category product successive views that is a number of successive page views of products belonging to a same category as a product that the user viewed and that is out of stock, based on the different product successive viewing information, and
   determines whether or not the degree of replenishment is changed and to which level of a plurality of levels the degree of replenishment is changed, based on a degree-of-replenishment setting criterion that is set according to the number of out-of-stock views and the number of same category product successive views, for each product.

(Appendix 6) A management method performed by a management device, the management method comprising:
acquiring viewing history information indicating a viewing history by a user to a product sold in a store in an electronic market,
calculating a number of out-of-stock views of each product, based on the viewing history included in the acquired viewing history information and determining whether or not to change a degree of replenishment that indicates a degree of priority with which a product is replenished,
changing the degree of replenishment of each product, based on a determination result in the determination,
the number of out-of-stock views being a number of times that a product that is out of stock is viewed, and
determining whether or not the degree of replenishment is changed and to which level of a plurality of levels the degree of replenishment is changed, based on a degree-of-replenishment setting criterion that is set according to the number of out-of-stock views, for each product.

(Appendix 7) A non-transitory computer-readable recording medium storing a program for causing a computer to perform processing comprising:
acquiring viewing history information indicating a viewing history by a user to a product sold in a store in an electronic market,
calculating a number of out-of-stock views of each product, based on the viewing history included in the acquired viewing history information and determining whether or not to change a degree of replenishment that indicates a degree of priority with which a product is replenished,
changing the degree of replenishment of each product, based on a determination result in the determination,
the number of out-of-stock views being a number of times that a product that is out of stock is viewed, and
determining whether or not the degree of replenishment is changed and to which level of a plurality of levels the degree of replenishment is changed, based on a degree-of-replenishment setting criterion that is set according to the number of out-of-stock views, for each product.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Industrial Applicability

According to the present disclosure, by calculating a degree of replenishment that represents a degree of priority with which inventory of products on the Internet is replenished, the inventory management can be suitably performed.

1. A management device, comprising one or more processors,
wherein the processors
acquire viewing history information indicating a viewing history by a user to a product sold in a store in an electronic market,
calculate a number of out-of-stock views of each product, based on the viewing history included in the acquired viewing history information and determine whether or not to change a degree of replenishment that indicates a degree of priority with which a product is replenished,
change the degree of replenishment of each product, based on a determination result in the determination,
the number of out-of-stock views being a number of times that a product that is out of stock is viewed, and
determine whether or not the degree of replenishment is changed and to which level of a plurality of levels the degree of replenishment is changed, based on a degree-of-replenishment setting criterion that is set according to the number of out-of-stock views, for each product.

2. The management device according to claim 1, wherein
in the viewing history information, a total number of views of each product that includes a view of the product when the product is out of stock and a view of the product when the product is in stock is included, and
the processors determines whether or not the degree of replenishment is changed and to which level of a plurality of levels the degree of replenishment is changed, based on a degree-of-replenishment setting criterion that is set according to the number of out-of-stock views and the total number of views, for each product.

3. The management device according to claim 1, wherein
in the viewing history information, leaving operation information indicating that after a product that is out of stock is viewed, the user left the electronic market is included, and
the processors
further calculate a number of leaving operations for each product, based on the leaving operation information, and
determines whether or not the degree of replenishment is changed and to which level of a plurality of levels the degree of replenishment is changed, based on a degree-of-replenishment setting criterion that is set according to the number of out-of-stock views and the number of leaving operations, for each product.

4. The management device according to claim 1, wherein
in the viewing history information, different product viewing information indicating that after a product that is out of stock is viewed, the user in the electronic market viewed a product different from the product is included, and
the processors
further calculate a number of same category product views that is a number of views of a product belonging to a same category as the product that the user viewed and that is out of stock, based on the different product viewing information, and
determines whether or not the degree of replenishment is changed and to which level of a plurality of levels the degree of replenishment is changed, based on a degree-of-replenishment setting criterion that is set according to the number of out-of-stock views and the number of same category product views, for each product.

5. The management device according to claim 1, wherein
in the viewing history information, different product successive viewing information indicating that after the product that is out of stock is viewed, the user in the electronic market successively views products different from the product is included, and
the processors
further calculate a number of same category product successive views that is a number of successive page views of products belonging to a same category as a product that the user viewed and that is out of stock, based on the different product successive viewing information, and
determines whether or not the degree of replenishment is changed and to which level of a plurality of levels the degree of replenishment is changed, based on a degree-of-replenishment setting criterion that is set according to the number of out-of-stock views and the number of same category product successive views, for each product.

6. A management method performed by a management device, the management method comprising:
acquiring viewing history information indicating a viewing history by a user to a product sold in a store in an electronic market,
calculating a number of out-of-stock views of each product, based on the viewing history included in the acquired viewing history information and determining whether or not to change a degree of replenishment that indicates a degree of priority with which a product is replenished,
changing the degree of replenishment of each product, based on a determination result in the determination,
the number of out-of-stock views being a number of times that a product that is out of stock is viewed, and
determining whether or not the degree of replenishment is changed and to which level of a plurality of levels the degree of replenishment is changed, based on a degree-of-replenishment setting criterion that is set according to the number of out-of-stock views, for each product.

7. A non-transitory computer-readable recording medium storing a program for causing a computer to perform processing comprising:
acquiring viewing history information indicating a viewing history by a user to a product sold in a store in an electronic market,
calculating a number of out-of-stock views of each product, based on the viewing history included in the acquired viewing history information and determining whether or not to change a degree of replenishment that indicates a degree of priority with which a product is replenished,
changing the degree of replenishment of each product, based on a determination result in the determination,
the number of out-of-stock views being a number of times that a product that is out of stock is viewed, and
determining whether or not the degree of replenishment is changed and to which level of a plurality of levels the degree of replenishment is changed, based on a degree-of-replenishment setting criterion that is set according to the number of out-of-stock views, for each product.
